(19) United States
(12) Patent Application Publication
(10) Pub. No.: US 2017/0337900 A1
(43) Pub. Date: Nov. 23, 2017

(54) WIRELESS USER INTERFACE PROJECTION FOR VEHICLES

(71) Applicant: Google Inc., Mountain View, CA (US)

(72) Inventors: Simon Dai, Mountain View, CA (US); Joseph Pieter Stefanus van Grieken, San Francisco, CA (US); Zhen Yu Song, Sunnyvale, CA (US)

(21) Appl. No.: 15/171,441

(22) Filed: Jun. 2, 2016

Related U.S. Application Data
(60) Provisional application No. 62/337,584, filed on May 17, 2016.

(51) Int. Cl. G09G 5/12; G06F 3/14; G09G 5/00; G06F 3/0484; H04W 76/02; H04W 4/00

(52) U.S. Cl. CPC G09G 5/12; H04W 76/02; H04W 4/008; G09G 5/005; G06F 3/0484; G06F 3/1454; G06F 3/1423; G09G 2380/10

(57) ABSTRACT

Methods, systems, and apparatus, including computer programs encoded on a computer storage medium, for wireless user interface projection for vehicles are disclosed. In one aspect, a method includes the actions of receiving, by a mobile device, a wireless signal transmitted by a processing unit of a vehicle that includes a screen, the wireless signal including an identifier for the processing unit. The actions further include determining that the identifier corresponds to a trusted processing unit to which the mobile device is configured to provide projected UI information. The actions further include automatically establishing a wireless connection between the mobile device and the processing unit that is associated with the identifier. The actions further include automatically providing, by the mobile device, projected UI information to the processing unit for display on the screen of the vehicle.

### CROSS REFERENCE TO RELATED APPLICATION

This application claims the benefit of U.S. Provisional Application No. 62/337,584, filed May 17, 2016, which is incorporated by reference

### TECHNICAL FIELD

This application generally relates to wireless communication, specifically, between a mobile device and a vehicle.

### BACKGROUND

Some mobile devices may be configured to display information on a vehicle head unit when the user plugs the phone into the car. When plugged into the vehicle, the mobile device provides, to the head unit, video data for display on the screen of the head unit.

### SUMMARY

In some implementations, a mobile device can be configured to wirelessly provide data for a graphical user interface to be displayed on a screen of a vehicle. The creation of the wireless connection and display of information to the vehicle's screen can be performed automatically when the mobile phone is brought into proximity of the vehicle. For example, in a set-up phase, a user's mobile device can be configured to recognize the user's vehicle. Then, when the mobile device is later brought into proximity of the vehicle, the mobile device can detect the presence of the head unit, establish a wireless connection with the head unit, and provide video for display on the screen of the vehicle, without requiring user input to initiate the connection and display. As a result, the mobile device can automatically project a user interface to the vehicle's screen simply by being brought inside the vehicle, without requiring the user to take the phone out of the user's pocket or bag. The wireless connection can permit two-way communication between the mobile device and the head unit, allowing user input to the head unit to be passed to the mobile device and processed to generate updated views of the user interface. As a result, processing and generation of user interface data can be performed by the mobile device, while interaction with the user takes place using the input and output capabilities of the vehicle.

Generally, systems that display video from a mobile device on a vehicle require a user to manually establish a wired connection between the mobile device and the vehicle. Instead of manually plugging in the mobile device to the automobile, a mobile device and a vehicle maybe configured to communicate over a wireless connection that has enough bandwidth for real-time streaming of video data, e.g., a Wi-Fi connection. To initially connect a mobile device to a vehicle head unit, a user should have the mobile device within range of a beacon signal that the head unit may periodically transmit. The mobile device receives the beacon signal and determines whether the head unit is configured to display video data received wirelessly from the mobile device. If so, then the mobile device initiates an authorization sequence where the user enters, into the mobile device, a code that appears on the head unit. Once the mobile device verifies that the codes match, the mobile device adds the head unit to a list of trusted head units.

With the head unit added to the list of trusted head units, the mobile device is now configured to automatically connect to the head unit when the mobile device is within range of the head unit. Therefore, a user may enter the vehicle with the mobile device in her purse, and the mobile device will detect the beacon signal. The mobile device will identify the beacon signal as belonging to a trusted head unit and automatically initiate a wireless connection and begin providing video data to the head unit.

An innovative aspect of the subject matter described in this specification may be implemented in a method that includes the actions of receiving, by a mobile device, a wireless signal transmitted by a processing unit of a vehicle that includes a screen, the wireless signal including an identifier for the processing unit; determining that the identifier corresponds to a trusted processing unit to which the mobile device is configured to provide projected UI information; and based on determining that the identifier corresponds to the trusted processing unit to which the mobile device is configured to provide projected UI information: automatically establishing a wireless connection between the mobile device and the processing unit that is associated with the identifier; and automatically providing, by the mobile device, projected UI information to the processing unit for display on the screen of the vehicle.

These and other implementations can each optionally include one or more of the following features. The actions further include based on determining that the identifier corresponds to the trusted processing unit to which the mobile device is configured to provide projected UI information, maintaining a screen of the mobile device in an inactive state. The actions further include in response to receiving the wireless signal, automatically initiating an application that is configured to provide the projected UI information. The actions further include determining display parameters of the screen of the vehicle; and generating projected UI information based on the display parameters of the screen. The actions further include receiving, by the mobile device, data from the processing unit that indicates user input into the processing unit; processing, by the mobile device, the data that indicates user input into the processing unit; and providing, by the mobile device, updated projected UI information based on processing the data that indicates user input.

The actions further include before receiving the wireless signal: receiving, by the mobile device, an earlier transmission of the wireless signal transmitted by the processing unit; determining that processing unit is included in a vehicle that includes a screen and that the processing unit is configured to display projected UI information on the screen; verifying challenge data that is input into the mobile device; and storing data indicating that the identifier corresponds to a trusted processing unit. The actions further include transmitting, to the processing unit and for display on the screen, the challenge data. The challenge data is verified after transmitting the challenge data. The actions further include receiving, from the processing unit, the challenge data that the processing unit displays on the screen. The challenge data is verified after receiving the challenge data. The wireless signal includes data indicating that the processing unit is configured to receive projected UI information, and the action of determining that processing unit is included in a vehicle that includes a screen and that the processing unit is configured to display projected UI information on the screen is based on the data indicating that the processing unit is configured to receive projected UI information.

The actions further include accessing data that indicates that the identifier included in the wireless signal is provided by a processing unit that is configured to display projected UI information. The action of determining that processing unit is included in a vehicle that includes a screen and that the processing unit is configured to display projected UI information on the screen is based on the data that indicates that the identifier included in the wireless signal is provided by a processing unit that is configured to display projected UI information. The actions further include establishing a second wireless connection between the mobile device and the processing unit that is associated with the identifier. The second wireless connection uses a different protocol than the first wireless connection. The first wireless connection is a Wi-Fi connection. The second wireless connection is a Bluetooth connection. The wireless signal transmitted by the processing unit is Bluetooth low energy signal. The wireless connection between the mobile device and the processing unit is a Wi-Fi connection. The action of providing the projected UI information to the processing unit for display on the screen of the vehicle includes providing data, generated by the mobile device, for video frames of an interactive user interface for display on the screen on of the vehicle.

Other implementations of this aspect include corresponding systems, apparatus, and computer programs recorded on computer storage devices, each configured to perform the operations of the methods.

Particular implementations of the subject matter described in this specification can be implemented so as to realize one or more of the following advantages. A mobile device can automatically wirelessly connect to a previously authenticated vehicle head unit without requiring action from the user. A mobile device may be prevented from automatically wirelessly connecting to a vehicle head unit without authorization from the user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example mobile device connecting to a processing unit of a vehicle that includes a screen.

FIG. 1A illustrates an example mobile device connected to a processing unit of a vehicle that includes a screen.

FIG. 2 illustrates an example mobile device initializing a connection with a processing unit of a vehicle that includes a screen.

FIG. 2A illustrates an example mobile device requesting input of an authentication code that appears on a screen of a vehicle.

FIG. 3 illustrates an example process of a mobile device connecting to a processing unit of a vehicle that includes a screen.

FIG. 4 illustrates an example of a computing device and a mobile computing device.

Like reference numbers and designations in the various drawings indicate like elements.

### DETAILED DESCRIPTION

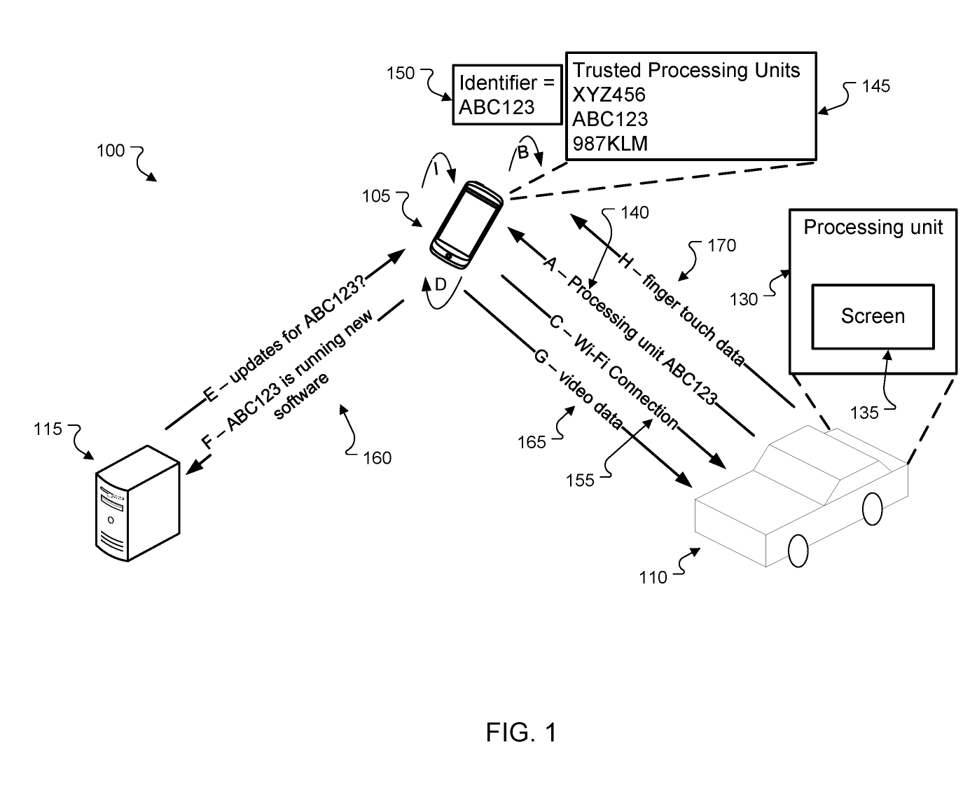

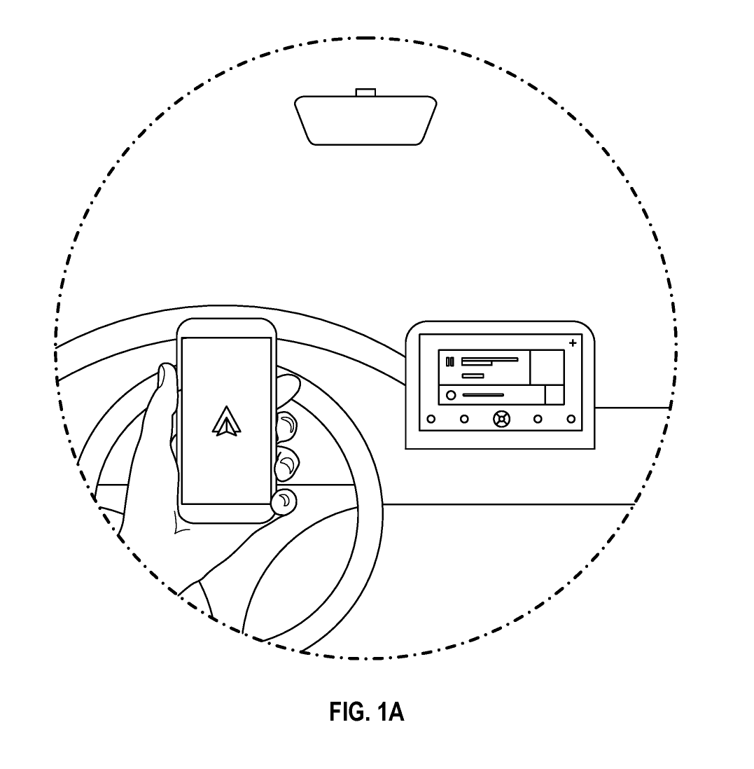

FIG. 1 illustrates an example mobile device 105 connecting to a processing unit 130 of a vehicle 110 that includes a screen 135. Briefly, and as described in more detail below, the mobile device 105 connects wirelessly to the processing unit 130 of the vehicle 110 so that the mobile device 105 can display projected user interface (UI) information onto the screen 135 that communicates with the processing unit 130. The processing unit 130 and the mobile device 105 may be in bidirectional communication such that application data from the mobile device 105 is displayed on the screen 135 where the user can interact with it. The processing unit 130 may transmit the data to the mobile device 105 for processing.

The vehicle 110 is equipped with a head unit that includes a screen 135 and a processing unit 130. The head unit may be located in the center of the dashboard and positioned so that the user can view and touch the screen 135 while in the car. The head unit may be configured to control various functions of the car, including, for example, the climate control system and the radio. The head unit may also be configured to communicate wirelessly with various devices. For example, the head unit may be able to wirelessly communicate with other devices through a Wi-Fi connection, a Bluetooth connection, a cellular connection, a WirelessHD connection, a WiGig connection, a Z-Wave connection, a Zigbee connection, or any other similar protocol. To notify nearby devices of this capability, in stage A, the processing unit 130 may periodically transmit a wireless signal 140. For example, the processing unit 130 may transmit the wireless signal every five seconds while the car is on or in auxiliary mode and while another device is not wirelessly connected to the processing unit 130. The wireless signal may include an identifier that uniquely identifies the processing unit. In some implementations, the wireless signal may include data identifying the type of processing unit and data indicating that the processing unit is configured to wirelessly communicate with other devices and receive projected UI information from the other devices. In some implementations, the wireless signal is a Bluetooth low energy signal such as an Eddystone beacon.

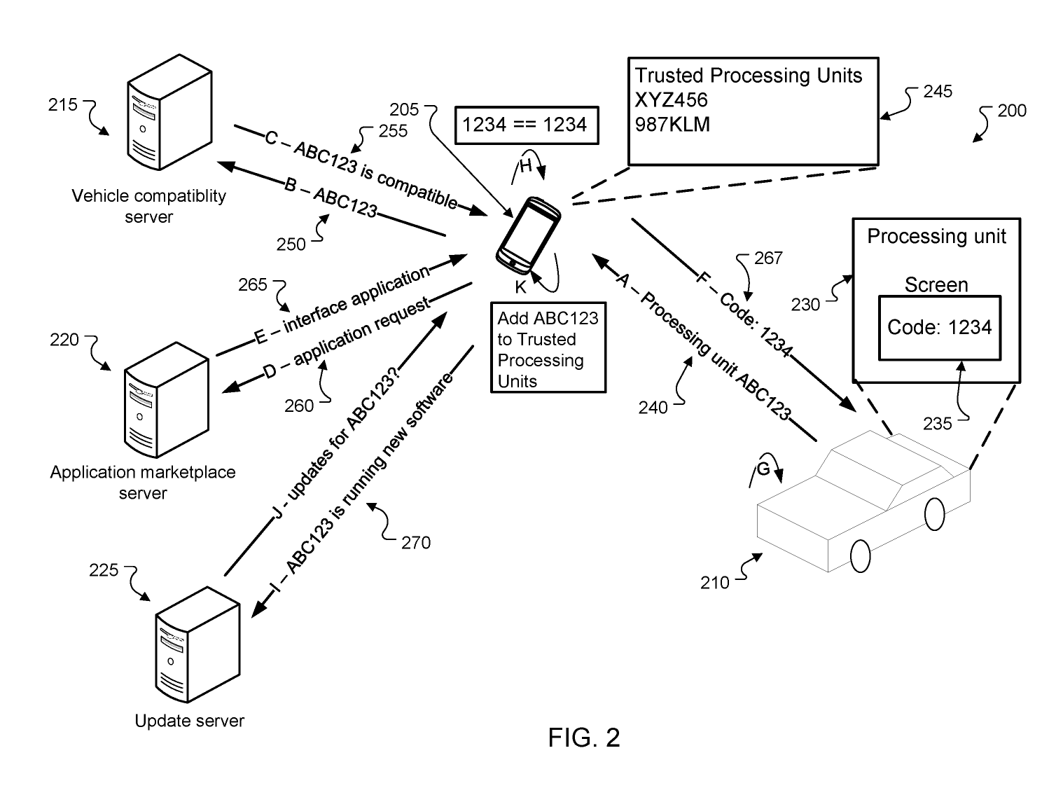

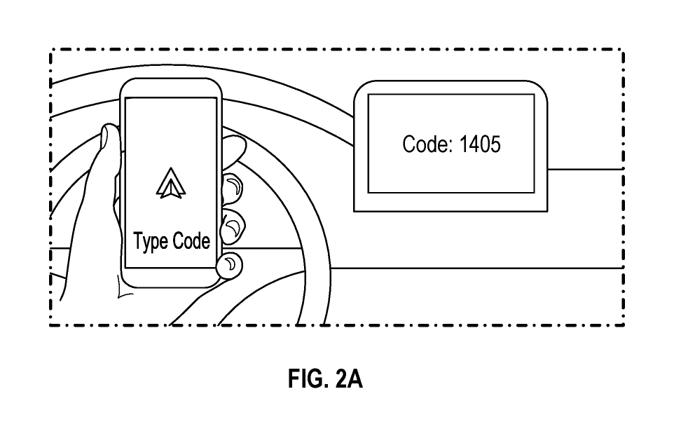

In stage B, the mobile device 105 receives and processes the wireless signal 140. The mobile device 105 decodes the wireless signal and extracts the processing unit identifier 150 that was included in the wireless signal. The mobile device 105 may store a list 145 of trusted processing units to which the mobile device 105 has previously connected and to which the user of the mobile device 105 has authorized connecting. The mobile device 105 compares the identifier 150 to the list 145 of trusted processing units and if the identifier matches an identifier on the list, then the mobile device 105 may automatically, and without requiring user input, proceed to stage C. In instances where the identifier does not match an identifier on the list of trusted processing units, the mobile device may proceed to the process described below in relation to FIG. 2. A trusted processing unit is a processing unit that the mobile device has previously connected to by the user authenticating the processing unit while mobile device is attempting to connect to it. This process is described below with respect to FIG. 2.

In some implementations, upon confirming that the identifier matches an identifier on the list of trusted processing units, the mobile device 105 may prompt the user whether to connect with the processing unit 130. For example, upon confirming that Black Sedan has a trusted processing unit 130, the mobile device 105 may display the prompt “Would you like to wirelessly connect to Black Sedan?” along with yes and no response options. If the user selects “yes,” then the mobile device proceeds to stage C. If the user selects “no,” then the mobile device does not connect to Black Sedan. In some implementations, if the user selects “no,” then the mobile device may prompt the user whether to remove the identifier of the processing unit 130 from the list of trusted processing units.

In stage C, the mobile device 105 initiates a wireless connection 155 with the processing unit 130 of the vehicle 110. In some implementations, the mobile device 105 automatically and without requiring user input wirelessly connects to the processing unit 130. In some implementations, the mobile device 105 appears to be in sleep mode while the mobile device 105 identifies and connects to the processing unit 130. For example, the screen 135 of the mobile device 105 may be blank during stages A to C and possibly during later stages also. In some implementations, the mobile device 105 indicates on the screen 135 of the mobile device 105 that the mobile device 105 is automatically wirelessly connecting to the processing unit 130. The wireless connection is a Wi-Fi connection, a Bluetooth connection, a cellular connection, a WirelessHD connection, a WiGig connection, a Z-Wave connection, a Zigbee connection, or any other similar protocol. In some implementations, the mobile device 105 may detect the processing unit 130 from a wireless signal 140 over one wireless protocol, e.g., Bluetooth, and then connect, for the purposes of providing projected UI information, to the processing unit 130 using a different wireless protocol, e.g., Wi-Fi.

In some implementations, the mobile device 105 executes stage D where the mobile device 105 opens an application that is configured to facilitate communications between the applications of the mobile device 105 and the processing unit 130. In some implementations, the functionality of this application may be built into the operating system of the mobile device. The functionality of the application may include processing application data into projected UI information that the processing unit 130 can understand and display on the screen 135 in the vehicle 110. For example, the application may receive map and direction data from a mapping application. The application generates projected UI information based on the map and direction data and based on the configuration of the screen 135 of the processing unit 130. The projected UI information may include rendered video data that the processing unit 130 can directly display on the screen 135. The mobile device may provide subsequent frames of the projected UI information at a rate that corresponds to the capabilities of the screen 135, for example, at a rate of fifteen frames per second. In some implementations and to conserve battery power, the frame rate may vary the frame rate depending on the application. A mapping application may necessitate a higher frame rate, while a home screen or messaging application may not require as high of a frame rate.

In some implementations, the projected UI information is a rendered video data stream that is encoded for display on the screen 135 where the processing unit 130 is only required to receive the projected UI information and provide it to the screen 135. In this instance, the mobile device 105 may be required to encode the projected UI information differently according to the particular parameters and requirements of different screens. The mobile device 105 may constantly provide rendered video data at a required frame rate and resolution according to the application and capabilities of the screen 135. In some implementations, the projected UI information is a compressed video stream using codecs such as H.264, HEVC, VP8, VP9, or any other similar video codec. In some implementations, the projected UI information is provided to the processing unit 135 using a transport protocol, e.g., Real-time Messaging Protocol, Real-time Transport Protocol, or any other similar protocol.

In some implementations, the mobile device 105 executes stage E where the mobile device 105 requests updated data from the server 115. The requested data may be related to updates to the processing unit 130 of the vehicle 110, for example, software updates. In stage F, the mobile device 105 receives the update 160 form the server 115 and updates the application that communicates with the processing unit 130 or updates the operating system if the functionality of the application is built into the operating system. In some implementations, the server 115 may automatically push updates to the mobile device 105 when the server 115 receives updates related to the processing unit 130. In this case, it would not be necessary for the mobile device 105 to request updated data from the server 115.

In stage G, the mobile device 105 automatically provides projected UI information 165 to the processing unit 130 for display on the screen 135 of the vehicle. The projected UI information may include rendered video data that the mobile device 105 generated based on the capabilities of the processing unit 130 and the screen 135. In some implementations the projected UI information may include compressed video data that the processing unit 130 would have to decode to generate the video frames to display on the screen 135. As noted above, the mobile device 105 may provide projected UI information at a specific frame rate and resolution. The frame rate and resolution may be based on a number of factors including the battery power of the mobile device 105, the type of data to be displayed on the screen 135 of the processing unit 130, the technical specifications of processing unit 130 and the screen 135, the quality of the wireless connection between the mobile device 105 and the processing unit 130, the internal temperature of the mobile device 105, and the type of wireless connection. For example, if the battery power is low and the wireless connection is poor, the frame rate or resolution or both may be reduced. As another example, if the type of data to be displayed on the screen 135 is mapping data and the battery power is low, the frame rate may be the typical frame rate for the mapping application with a reduced resolution. In some implementations, the application initiated during stage D may communicate with the applications of the mobile device 105 and generate the projected UI information based on the data from the applications.

FIG. 1A illustrates an example mobile device that is wirelessly connected to a processing unit of a vehicle. In this example, the mobile device displays data on the screen of the mobile device indicating that the mobile device connected to the processing unit. The mobile device may deactivate the screen of the mobile device after the mobile device has been wirelessly connected to the processing for a particular amount of time. In some implementations, the mobile device may maintain the screen in a deactivated state while initializing the wireless connection if the mobile device detects it is in a pocket, bag, purse, or other location where the screen of the mobile device would not be viewable by the user.

In stage H, the user interacts with the processing unit 130 while the mobile device 105 is providing projected UI information to the processing unit 130. The processing unit 130 may encode the data using a particular technique that is specific to the operating system of the mobile device 105. Upon interaction, the processing unit 130 generates data 170 that describes the interaction. For example, the interaction may be the user touching a particular location on the screen 135. In this instance, the processing unit 130 may indicate, using a coordinate system, where the touch occurred. In some implementations, only a portion of the screen 135 may be dedicated to displaying the projected UI information. Other areas of the screen 135 may be related to adjusting the radio or the climate control system. When the user interacts with the areas of the screen 135 that is not dedicated to displaying the projected UI information, it may not be necessary for the processing unit 130 generated any interaction data to provide to the mobile device 105.

In some implementations, the processing unit 130 may be configured to generate interaction data according to a process that is specific to the processing unit 130 instead of a process that is specific to the mobile device 105. In this instance, the interface application of the mobile device would be configured to decode the interaction data received from the processing unit 130 into data that could later be processed by the mobile device 105. For example, the user may touch the screen 135, and the processing unit 130 uses a proprietary encoding scheme to encode the location of the touch. The processing unit 130 transmits the encoded touch data to the mobile device 105. The mobile device 105 receives the encoded touch data through the interface application. The interface application decodes the touch data and then processes the decoded touch data based on the location of the touch. In some implementations, the interface application stays updated through the techniques described in stages E and F.

In stage I, the mobile device 105 generates response data to the interaction data 170 received from the processing unit 130. In some implementations, the response data includes updated projected UI information such as a new interface to display on the screen 135. As an example, a user may select a map icon on the screen 135. The processing unit 130 identifies the location of the touch and sends interaction data to the mobile device indicating the location of the touch. Because the mobile device 105 can match the location of the touch with the current display of the screen 135, the mobile device 105 can determine that the user touched the map icon. The mobile device 105 may then initiate the mapping application that then communicates with the interface application. The interface application generates projected UI information to provide to the processing unit 130. The processing unit 130 then displays the mapping user interface on the screen 135.

As another example, the user may select a phone icon on the screen 135. The processing unit 130 identifies the location of the touch and sends interaction data to the mobile device indicating the location of the touch. Because the mobile device 105 can match the location of the touch with the current display of the screen 135, the mobile device 105 can determine that the user touched the phone icon. The mobile device 105 may then initiate the phone application that then communicates with the interface application. The interface application generates projected UI information to provide to the processing unit 130. The processing unit 130 then displays the phone user interface on the screen 135. The phone user interface may include contacts that the user can select or button to select to speak a contact's name. Upon selection of the voice button, the processing unit 130 and the mobile device 105 may exchange data so that a prompt for the user to speak is displayed on the screen 135. A microphone of the vehicle 110 may receive a spoken utterance. The processing unit 130 may process and transmit the corresponding audio data to the mobile device 105. At that point, the mobile device 105 may initiate a phone call and communicate the phone call data with the microphone and speakers of the vehicle 110.

In some implementations, the mobile device 105 and the processing unit 130 may communicate through a second wireless connection while the wireless connection for the projected UI connection is active. For example, the phone may also connect with Bluetooth. In this instance, upon initiation of a phone call using the processing unit 130, the mobile device may switch to the second wireless connection to continue the phone call. For example, once the mobile device 105 receives the audio data that includes a contact's name, the mobile device 105 may initiate the phone call and switch to communicating with the microphone and speakers of the vehicle using the second wireless connection while still maintaining the wireless connection for the projected UI connection.

FIG. 2 illustrates an example mobile device 205 initializing a connection with a processing unit 230 of a vehicle 210 that includes a screen 235. Briefly, and as described in more detail below, the mobile device 205 initiates a wireless connection to the processing unit 230 of the vehicle 210 so that the mobile device 205 can automatically connect to the processing unit 230 to display projected UI information onto a screen 235 that communicates with the processing unit 230. Once the mobile device 205 initializes the communication, the mobile device 205 stores an identifier for the processing unit 230 in a list of trusted processing units.

In stage A, the processing unit 230 periodically transmits a wireless signal 240. The wireless signal 240 may be similar to the wireless signal 140 described in relation to stage A in FIG. 1. For example, the wireless signal 240 may be a beacon signal that includes data identifying the type of processing unit and possibly data indicating that the processing unit 230 is configured to wirelessly communicate with other devices and receive projected UI information from the other devices. The mobile device 205 may receive this wireless signal if the mobile device 205 is within range of the processing unit 230. In some implementations, a user may activate a scanning mode of the mobile device 205. In scanning mode, the mobile device 205 is able to detect and process a wireless signal such as the wireless signal transmitted by the processing unit 230. Once the mobile device 205 receives the wireless signal, the mobile device extracts the identifier for the processing unit 230.

In stage B, the mobile device 205 wirelessly transmits the identifier 250 of the processing unit 230 to a vehicle compatibility server 215. The vehicle compatibility server 215 maintains a record of the vehicles and corresponding processing units that are configured to wirelessly communicate with other devices and receive projected UI information from the other devices. The vehicle compatibility server 215 may be updated periodically as new vehicle models are made to be compatible. In stage C, the vehicle compatibility server 215 transmits data 255 indicating that the processing unit 230 is configured to wirelessly communicate with other devices and receive projected UI information from the other devices. In instances where the vehicle compatibility server 215 returns data indicating that the processing unit 230 is not configured to wirelessly communicate with other devices and receive projected UI information from the other devices, then the mobile device 205 may add the identifier to a record that is stored locally on the mobile device 205 that indicates that the processing unit 230 is not compatible. With this record, the mobile device 205 may first be able to check the locally stored record to determine whether the processing unit 230 is compatible. In some implementations, the mobile device 205 may first check the locally stored record 245 of trusted processing units before transmitting the identifier of the processing unit to a vehicle compatibility server 215. If the mobile device 205 does not find a match in the record 245, then the mobile device queries the vehicle compatibility server 215.

In some implementations, the it is not necessary for the mobile device 205 to query the vehicle compatibility server 215 because the wireless signal includes data that indicates that it is configured to wirelessly communicate with other devices and receive projected UI information from the other devices. Once the mobile device 205 has determined the processing unit is compatible, the mobile device 205 may prompt the user whether to continue to connect to the processing unit 230.

In some implementations, the mobile device 205 executes stage D where the mobile device 205 sends a request 260 an interface application from the application marketplace server 220. The interface application may be similar to the application describe above in stage D of FIG. 1. The interface application is configured to interface between an application running on the mobile device 205 such as a mapping application and the processing unit 230. The interface application generates projected UI information for display on the screen 235 of the processing unit 230. In some implementations, the operation system includes the functionality of the interface application. In this case, it is not necessary for the mobile device 205 to request the interface application. In some implementations, the mobile device 205 may prompt the user whether to download the interface application and indicate that without the application, the mobile device 205 may not be able to display video data on the screen 235 of the processing unit 230. Once the application marketplace server 220 receives the request for the interface application, in stage E, the application marketplace server 220 transmits the corresponding data 265 for the interface application to the mobile device 205 for installation.

There may be multiple ways for the user authorize a connection between the mobile device 205 and the processing unit 230. Without an authorization process, an attacker may be able to connect a processing unit of another vehicle to the mobile device 205 when the mobile device 205 is within range of the attacking processing unit. Stages F, G, and H illustrate an example authentication process. At stage F, the mobile device 205 generates challenge data 267 and wirelessly transmits the challenge data to the processing unit 230. The challenge data may also include instructions for how to display the challenge data. In some implementations, the challenge data may be included in projected UI information for display on the processing unit 230.

At stage G, the processing unit 230 displays the challenge data on the screen 235 of the processing unit 230. The mobile device 205 may include instructions for the user to enter the challenge data displayed on the screen 235 of the processing unit 230 or the screen 235 of the processing unit 230 may display instructions for the user to enter the challenge data into the mobile device 205. At stage H, the mobile device 205 compares the challenge data that the user entered into the mobile device 205 to the challenge transmitted wirelessly to the processing unit 230. If the two match, then the mobile device 205 may proceed to stage I. If the two do not match, then then the mobile device 205 may request that the user re-enter the challenge data or the user may request to restart the authentication process.

In another example authentication process, the processing unit 230 generates the challenge data and wirelessly transmits the challenge data to the mobile device 205 along with instructions not to display the challenge code, and instead request that the user enter the challenge data that is displayed on the screen 235 of the processing unit 230. The processing unit 230 displays the challenge data and the user enters the matching data into the mobile device 205. The mobile device 205 compares the two and if they match, then the mobile device may proceed to stage I. If the two do not match, then the mobile device 205 may request that the user re-enter the challenge data or the user may request to restart the authentication process.

FIG. 2A illustrates an example mobile device requesting input of an authentication code that appears on a screen of a vehicle. In this example, the screen of the processing unit is displaying a code of 1405. The mobile device requests that the user enter the code that appears on the screen of the processing unit. The mobile device may also display a symbol that represents the processing unit. The symbol may be unique to the processing unit and may also appear on the screen of the processing unit, or the symbol may be a symbol that indicates the mobile device is attempting to initiate a connection to the processing unit for the purpose of providing projected UI information.

In some implementations, the mobile device 205 executes stages I and J. Stages I and J are similar to stages E and F in FIG. 1. In stage I, the mobile device 205 requests update data from the update server 225. The requested data may be related to updates to the processing unit 230 of the vehicle 210 and may be to update the interface application to improve communication between the processing unit 230 and the interface application. In stage J, the update server 225 transmits the updated data 270 to the mobile device 205. In some implementations, the vehicle compatibility server 215, the application marketplace server 220, and the update server 225 are the same server. In some implementations two of the vehicle compatibility server 215, the application marketplace server 220, and the update server 225 are the same server.

In stage K, the mobile device 205 adds the identifier for the processing unit 230 to a list of trusted identifiers. The mobile device 205 may be configured to automatically connect to those processing units that correspond to trusted identifiers without requesting permission from the user. In some implementations, the mobile device 205 may then prompt the user to select various options for how the mobile device 205 should communicate with the processing unit 230. The options may related to how to adjust the frame rate or resolution when the battery is low. The options may also related to when to automatically connect to trusted processing units. The user may select to only connect to trusted processing units when the mobile device 205 is plugged into a power source or when the battery power of mobile device 205 is above a particular level. The options may also relate to whether to prompt the user before connecting to particular trusted processing networks or whether to connect automatically.

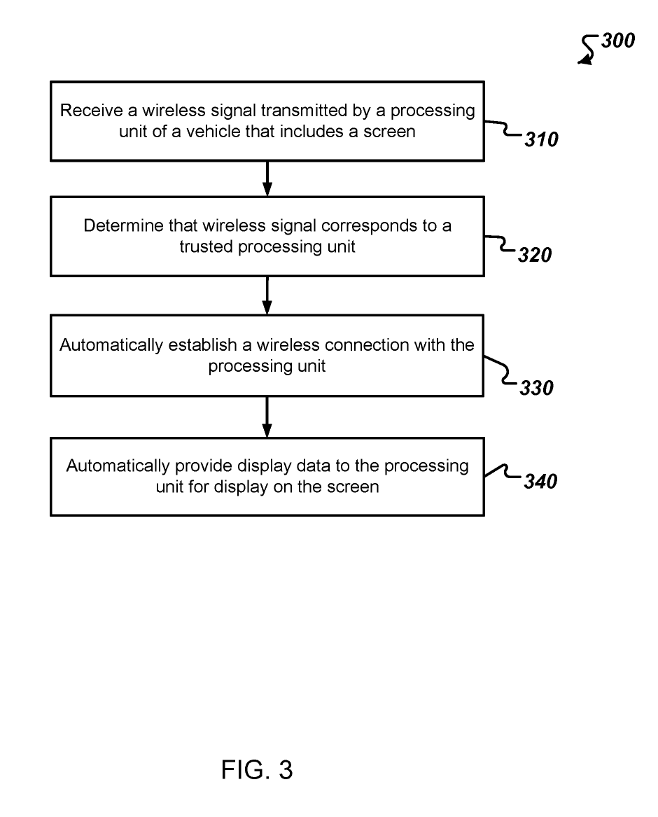

FIG. 3 illustrates an example process 300 of a mobile device connecting to a processing unit of a vehicle that includes a screen. In general, the process 300 identifies a processing unit of a vehicle that includes a screen and automatically establishes a wireless connection between the processing unit and the executing device upon verifying that the processing unit is a trusted processing unit. The process 300 will be described as being performed by a computer system comprising at one or more computers, for example, the mobile devices 105 or 205 as shown in FIG. 1 or 2.

The system receives a wireless signal transmitted by a processing unit of a vehicle that includes a screen and the wireless signal includes an identifier for the processing unit (310). In some implementations, the wireless signal is a Bluetooth low energy signal and is transmitted periodically. In some implementations, the wireless signal includes data that indicates that the processing unit is configured to receive and display projected UI information. In some implementations, a user of the system may activate a discovery mode of the system to receive and identify the wireless signal. In other implementations, the receipt and processing of the wireless signal may happen automatically once the system is within range of the processing unit.

The system determines that the identifier corresponds to a trusted processing unit to which the system is configured to provide projected UI information (320). Upon receiving the wireless signal, the system may initially check a list of trusted processing units to determine whether the identifier that is included in the wireless signal corresponds to a trusted processing unit that is on the list. These trusted processing units may be units to which the system has previously wirelessly connected. In some implementations, the trusted processing units may also be processing units to which the system has previously connected to using a wired connection. If the processing unit is a trusted processing unit, then the system proceeds to 330. If the processing unit is not on the trusted processing unit list, then the system proceeds to the verification process described below.

The system, based on determining that the identifier corresponds to the trusted processing unit to which the system is configured to provide projected UI information, automatically establishes a wireless connection between the system and the processing unit that is associated with the identifier (330). In some implementations, before establishing the wireless connection, the system automatically opens an interface application that is configured to receive data from other applications running on the system and generate projected UI information for the processing unit based on the other applications. In some implementations, the operating system includes the functionality of the interface application. In some implementations, the wireless connection is a Wi-Fi connection and the identifier in the initial wireless signal is a service set identifier.

The system, based on determining that the identifier corresponds to the trusted processing unit to which the system is configured to provide projected UI information, automatically providing, by the system, projected UI information to the processing unit for display on the screen of the vehicle (340). In some implementations, the system queries a server for any updates related to the processing unit, for example, any software updates that may affect the functionality of the processing unit. Because the system has previously connected to the processing unit the system is familiar with the display parameters of the screen of the processing unit. In some implementations, however, the system may query a server or the processing unit for the display parameters of the screen, for example, the resolution, the portion of the screen dedicated to displaying the projected UI information, any frame rate requirements, or any user interface capabilities of the processing unit.

In some implementations, while the system identifies and connect to the processing unit, the system appears to be inactive, in a sleep state, a screen of the system remains blank, or a screen displays a message or symbol indicating that it is connected to the processing unit. In an inactive state, the mobile device may maintain the components of the mobile device that are not involved in generating projected UI information and not involved in receiving and processing input data received from the processing unit in a lower power state, for example, turning off the screen. Once the system is wirelessly connected to the processing unit, the user may interact with the screen of the processing unit. Upon interaction, the processing unit determines that the user has interacted with the screen and identifies the location of the interaction. The processing unit wirelessly transmits interaction data to the system, and the system processes the interaction. The system determines an adjustment to a display on the screen and generates the projected UI information to wirelessly send to the processing unit for displaying the adjustment.

In some implementations, the system may also connect to the processing unit through a second wireless connection using a different protocol. For example, the system may connect to the processing unit using a Wi-Fi connection for the purposes of transmitting projected UI information and also using a Bluetooth connection.

In the case where the processing unit is not on a list of trusted processing units, the system may execute the following process to authenticate the processing unit. Upon determining that the identifier of the periodically transmitted wireless signal does not match an identifier on the trusted processing list, the system determine whether the processing unit is configured to display projected UI information transmitted from the system. In one instance, the processing unit may include this information in the periodically transmitted wireless signal. In another instance, the system may query a server to determine whether the processing unit associated with the identifier is configured to display projected UI information.

Once the system determines that the processing unit is configured to display projected UI information, the system may then initiate a challenge sequence where the user inputs into the system a challenge code that appears on the screen of the processing unit. In some implementations, the system may wirelessly transmit the challenge data to the processing unit for display and request the user to enter the displayed challenge data into the system. In some implementations, the processing unit may display the challenge data and wirelessly transmit the same challenge data to the system. The system may then request the user to enter the challenge data. Once the system verifies that the challenge data matches, the system may then add the processing unit to the list of trusted processing units and the system can begin transmitting projected UI information to the processing unit.

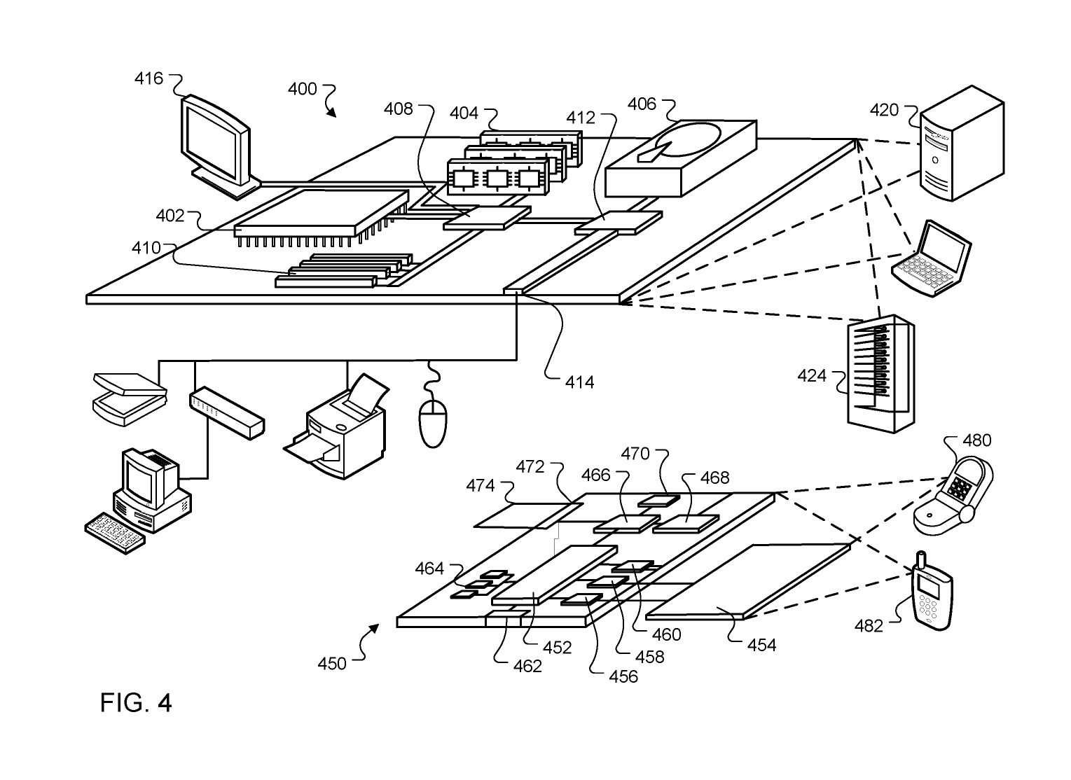

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver. In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving, by a mobile device, a wireless signal transmitted by a processing unit of a vehicle that includes a screen, the wireless signal including an identifier for the processing unit;
determining that the identifier corresponds to a trusted processing unit to which the mobile device is configured to provide projected UI information; and
based on determining that the identifier corresponds to the trusted processing unit to which the mobile device is configured to provide projected UI information:
automatically establishing a wireless connection between the mobile device and the processing unit that is associated with the identifier; and
automatically providing, by the mobile device, projected UI information to the processing unit for display on the screen of the vehicle.

2. The method of claim 1, comprising:
based on determining that the identifier corresponds to the trusted processing unit to which the mobile device is configured to provide projected UI information, maintaining a screen of the mobile device in an inactive state.

3. The method of claim 1, comprising:
in response to receiving the wireless signal, automatically initiating an application that is configured to provide the projected UI information.

4. The method of claim 1, comprising:
determining display parameters of the screen of the vehicle; and
generating projected UI information based on the display parameters of the screen.

5. The method of claim 1, comprising:
receiving, by the mobile device, data from the processing unit that indicates user input into the processing unit;
processing, by the mobile device, the data that indicates user input into the processing unit; and
providing, by the mobile device, updated projected UI information based on processing the data that indicates user input.

6. The method of claim 1, comprising:
before receiving the wireless signal:
receiving, by the mobile device, an earlier transmission of the wireless signal transmitted by the processing unit;
determining that processing unit is included in a vehicle that includes a screen and that the processing unit is configured to display projected UI information on the screen;
verifying challenge data that is input into the mobile device; and
storing data indicating that the identifier corresponds to a trusted processing unit.

7. The method of claim 6, comprising:
transmitting, to the processing unit and for display on the screen, the challenge data,
wherein the challenge data is verified after transmitting the challenge data.

8. The method of claim 6, comprising:
receiving, from the processing unit, the challenge data that the processing unit displays on the screen,
wherein the challenge data is verified after receiving the challenge data.

9. The method of claim 6, wherein:
the wireless signal includes data indicating that the processing unit is configured to receive projected UI information, and
determining that processing unit is included in a vehicle that includes a screen and that the processing unit is configured to display projected UI information on the screen is based on the data indicating that the processing unit is configured to receive projected UI information.

10. The method of claim 6, comprising:
accessing data that indicates that the identifier included in the wireless signal is provided by a processing unit that is configured to display projected UI information,
wherein determining that processing unit is included in a vehicle that includes a screen and that the processing unit is configured to display projected UI information on the screen is based on the data that indicates that the identifier included in the wireless signal is provided by a processing unit that is configured to display projected UI information.

11. The method of claim 1, comprising:
establishing a second wireless connection between the mobile device and the processing unit that is associated with the identifier,
wherein the second wireless connection uses a different protocol than the first wireless connection.

12. The method of claim 11, wherein:
the first wireless connection is a Wi-Fi connection, and
the second wireless connection is a Bluetooth connection.

13. The method of claim 1, wherein the wireless signal transmitted by the processing unit is Bluetooth low energy signal.

14. The method of claim 1, wherein the wireless connection between the mobile device and the processing unit is a Wi-Fi connection.

15. The method of claim 1, wherein providing the projected UI information to the processing unit for display on the screen of the vehicle comprises providing data, generated by the mobile device, for video frames of an interactive user interface for display on the screen on of the vehicle.

16. A system comprising:
one or more computers and one or more storage devices storing instructions that are operable, when executed by the one or more computers, to cause the one or more computers to perform operations comprising:
receiving, by a mobile device, a wireless signal transmitted by a processing unit of a vehicle that includes a screen, the wireless signal including an identifier for the processing unit;
determining that the identifier corresponds to a trusted processing unit to which the mobile device is configured to provide projected UI information; and
based on determining that the identifier corresponds to the trusted processing unit to which the mobile device is configured to provide projected UI information:
automatically establishing a wireless connection between the mobile device and the processing unit that is associated with the identifier; and
automatically providing, by the mobile device, projected UI information to the processing unit for display on the screen of the vehicle.

17. The system of claim 16, wherein the operations further comprise:
based on determining that the identifier corresponds to the trusted processing unit to which the mobile device is configured to provide projected UI information, maintaining a screen of the mobile device in an inactive state.

18. The system of claim 16, wherein the operations further comprise:
in response to receiving the wireless signal, automatically initiating an application that is configured to provide the projected UI information.

19. The system of claim 16, wherein the operations further comprise:
determining display parameters of the screen of the vehicle; and
generating projected UI information based on the display parameters of the screen.

20. A non-transitory computer-readable medium storing software comprising instructions executable by one or more computers which, upon such execution, cause the one or more computers to perform operations comprising:
receiving, by a mobile device, a wireless signal transmitted by a processing unit of a vehicle that includes a screen, the wireless signal including an identifier for the processing unit;
determining that the identifier corresponds to a trusted processing unit to which the mobile device is configured to provide projected UI information; and
based on determining that the identifier corresponds to the trusted processing unit to which the mobile device is configured to provide projected UI information:
automatically establishing a wireless connection between the mobile device and the processing unit that is associated with the identifier; and
automatically providing, by the mobile device, projected UI information to the processing unit for display on the screen of the vehicle.
